(19) United States
(12) Patent Application Publication
(10) Pub. No.: US 2011/0196596 A1
(43) Pub. Date: Aug. 11, 2011

(54) METHOD AND DEVICE FOR PREVENTING WATER DAMAGE IN INTERNAL COMBUSTION ENGINES

(76) Inventors: Roland SCHLESER, Saarbruecken (DE); Hansjoerg VEITEL, Schwaebisch Hall (DE); Daniel DAMM, Ludwigsburg (DE)

(21) Appl. No.: 13/023,166

(22) Filed: Feb. 8, 2011

(30) Foreign Application Priority Data
Feb. 8, 2010 (DE) 10 2010 001 655.1

(51) Int. Cl. F02D 17/04; F02P 11/02; G06F 19/00

(52) U.S. Cl. 701/112; 123/198 DC; 123/198 DB

(57) ABSTRACT

A method for preventing a water impact in an internal combustion engine includes: detecting whether water has entered an air supply system of the internal combustion engine; and stopping the internal combustion engine if it is determined that water has entered.

### CROSS-REFERENCE TO RELATED APPLICATIONS

The present application claims priority to Application No. 10 2010 001 655.1, filed in the Federal Republic of Germany on Feb. 8, 2010, which is expressly incorporated herein in its entirety by reference thereto.

### FIELD OF THE INVENTION

The present invention relates to internal combustion engines, in particular to internal combustion engines that are operated in the proximity of water. In particular, the present invention relates to internal combustion engines that are used for boats, jet skis, off-road vehicles, all-terrain vehicles (ATVs or Quads), off-road motorcycles and the like. Furthermore, the present invention relates to measures to prevent water from the environment to enter the combustion chambers of the cylinders of the internal combustion engine.

### BACKGROUND INFORMATION

Internal combustion engines require air for their operation in order to burn fuel in the combustion chambers of cylinders. This air, which is aspirated from the environment, is supplied to the cylinders via an air supply system. Internal combustion engine, which are used in the proximity of water, are exposed to the danger that they could aspirate water instead of air from the environment. Such a danger exists, for example, if the intake port is immersed in water or if spray water enters the intake port. If water enters a combustion chamber, then a so-called water impact may occur, since the aspirated water—in contrast to air—cannot be compressed. This results in a sudden blockage of the piston in the cylinder. The internal combustion engine may be severely damaged as a consequence, even resulting in a total loss. Particularly when using the internal combustion engine as a drive engine for boats or jet skis, dangerous situations may occur if the internal combustion engine fails at sea.

Past measures to prevent water from entering the internal combustion engine provide for an appropriate design of the intake tract such that water cannot readily enter the combustion chambers of cylinders. Such designs, however, require a relatively large amount of space and in many cases contradict the technical requirements of engine construction such as e.g. the shape of the intake manifold for preventing vibrations and the like.

### SUMMARY

Example embodiments of the present invention provide a method and a device for preventing water damage in internal combustion engines, which render a special design of the intake manifold obsolete and prevent water from entering the internal combustion engine in a manner that is as simple as possible.

According to example embodiments, a method for preventing a water impact in an internal combustion engine is provided. The method includes: detecting whether water has entered an air supply system of the internal combustion engine; and stopping the internal combustion engine if it was determined that water has entered.

One aspect of the above-described method is to detect water that has entered, e.g. by a suitable sensor system in an air supply system of an internal combustion engine, and to stop the internal combustion engine when water is detected in the air supply system.

Furthermore, there may be a provision for the internal combustion engine to be stopped by one or more of the following measures: stopping the supply of fuel; and stopping a generation of an ignition spark.

According to example embodiments, simultaneously or immediately after stopping the internal combustion engine, an intake valve may be kept closed permanently, in particular until the next start of the internal combustion engine. This serves to prevent a further intake of water as a result of the internal combustion engine running on after it was switched off.

According to example embodiments, simultaneously or immediately after stopping the internal combustion engine, a throttle valve or a shutoff valve in an air supply system upstream from an intake valve in a cylinder may be kept closed permanently, in particular until the next start of the internal combustion engine.

Furthermore, a new start of the internal combustion engine may be permitted only after a confirmation, in particular after an operation of an operating element.

According to another aspect, a device for preventing a water impact in an internal combustion engine is provided. The device includes: a water detector for detecting whether water has entered an air supply system of the internal combustion engine; and a control unit for performing an activation, by which the internal combustion engine is stopped if it was determined that water has entered.

Furthermore, the water detector may be situated in a section of the air supply system, in which water initially accumulates when it enters.

According to another aspect, an engine system is provided having an internal combustion engine and the above device.

According to another aspect, a computer program product is provided, which includes a program code that implements the above method when it is executed on a data processing unit.

Example embodiments are explained in greater detail below with reference to the attached drawings.

### BRIEF DESCRIPTION OF THE DRAWINGS

FIG. 1 is a schematic representation of an engine system of an internal combustion engine.

FIG. 2 is a flow chart for illustrating a method for preventing water impacts in the internal combustion engine of FIG. 1.

### DETAILED DESCRIPTION

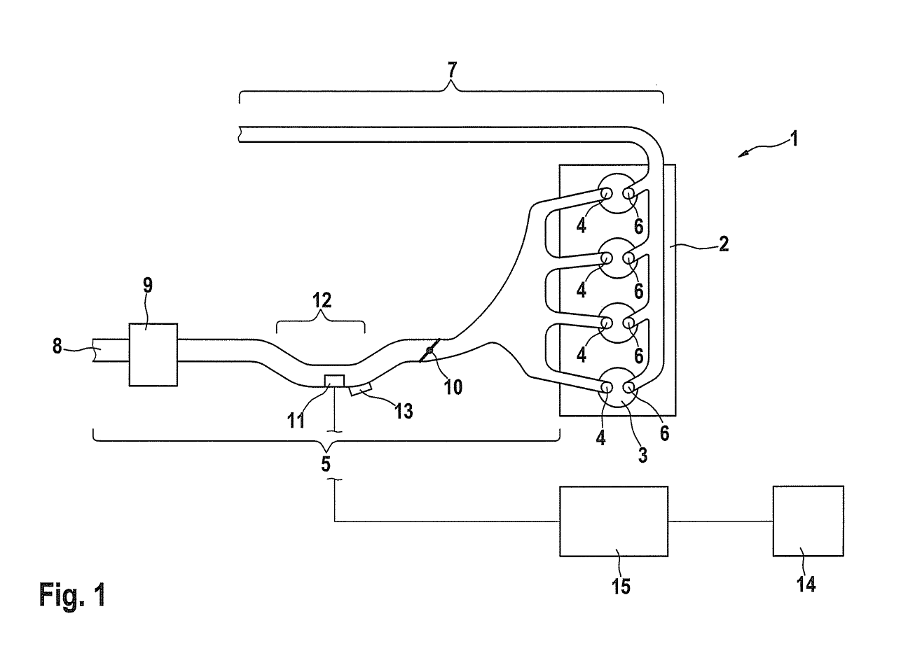

FIG. 1 shows an engine system 1 with an internal combustion engine 2. Internal combustion engine 2 may be an Otto engine, for example, or a Diesel engine, and includes four cylinders 3 in the exemplary embodiment shown. Internal combustion engine 2 is supplied with the air required for burning fuel via an air supply system 5.

Each of the cylinders 3 is equipped with an intake valve 4, via which the supplied air may be let into cylinders 3. Cylinders 3 furthermore have exhaust valves 6, via which the combustion exhaust gases may be discharged in an exhaust gas discharge section 7.

In air supply system 5, air is supplied via an intake port 8, an air filter 9, and a throttle valve 10 to intake valves 4 of cylinders 3.

A control unit 15 is provided, which operates internal combustion engine 2. As a function of a specified setpoint torque, inter alia, control unit 15 controls the quantity of fuel supplied to cylinders 3, the operation of intake valves 4 and exhaust valves 6, and the position of throttle valve 10 such that the resulting drive torque provided by the engine corresponds as much as possible to the setpoint torque.

Depending on the area where engine system 1 is used, it is possible that water enters air supply system 5 via intake port 8. It is necessary to prevent this water from reaching the combustion chambers of cylinders 3 via intake valves 4, since otherwise water impacts could result. Water impacts occur when a combustion chamber fills with water and a piston in the respective cylinder 3 is blocked due to the low compressibility of water.

For this reason, example embodiments of the present invention provide for situating a water detector 11 in a section of air supply system 5, which water detector 11 detects water that has entered air supply system 5 and signals the fact that water has entered to control unit 15. In particular, air supply system 5 is developed such that water, which has entered through intake port 8, first collects in a defined section 12, which represents the lowest-lying area of air supply system 5. Water detector 11 is then situated in this section such that small quantities of water which have entered can already be detected in air supply system 5.

Alternatively, there may be a provision that, as a function of the quantity of water collecting in section 12, the water detection is triggered only once a certain quantity of water has been exceeded such that an emergency switch-off does not occur in the case of a quantity of water that is harmless for the operation of engine system 1.

In Otto engines, section 12 is preferably situated in the area of air supply system 5 upstream from throttle valve 10.

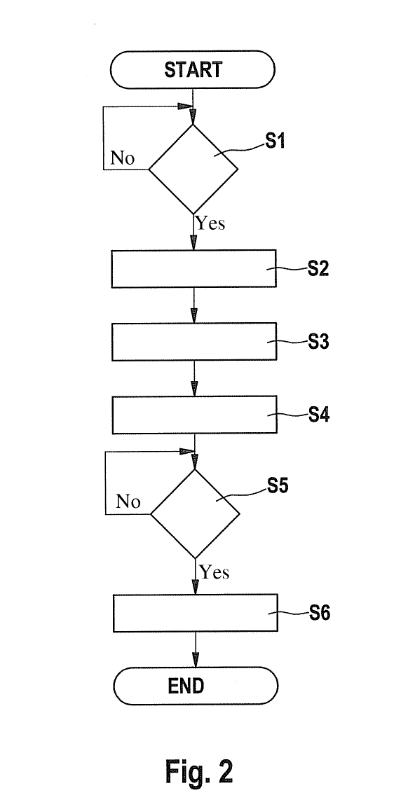

FIG. 2 shows a flow chart for illustrating a method for preventing water damage in an internal combustion engine. In step S1, water detector 11 is queried in order to determine whether water has entered air supply system 5. As long as no water has entered air supply system 5 (alternative: no), the query of water detector 11 is repeated.

If it is determined that water has entered air supply system 5 (alternative: yes), then internal combustion engine 2 is stopped immediately by control unit 15 in step S2. Internal combustion engine 2 is stopped by switching off the fuel supply and, in Otto engines, by switching off the ignition spark production.

Since, even after control unit 15 has switched off internal combustion engine 2, internal combustion engine 2, or more precisely, the drive shaft of internal combustion engine 2, runs on and therefore aspiration movements of pistons in combustion chambers of cylinders 3 occur, the water in air supply system 5 may even be aspirated shortly after switching off internal combustion engine 2. For this reason, immediately after switching off the internal combustion engine in step 42, intake valves 4 are closed in step 53 in order to prevent any water from entering the combustion chambers of cylinders 3. If internal combustion engine 2 is an Otto engine, then throttle valve 10 in air supply system 5 is likewise closed in order to prevent water already at this point from advancing in the direction of intake valves 4. As a result, it may possibly be easier to remove the water that has entered air supply system 5.

While normally no throttle valve is provided in Diesel engines, there may be a provision in air supply system 5 that, instead of throttle valve 10, a shutoff valve (not shown) is provided, which is open in normal operation of engine system 1 and is closed only when water enters air supply system 5.

In step S4, the user of engine system 1, e.g. a boat operator, if the engine system is used in a boat, is signaled that water has entered air supply system 5 and that internal combustion engine 2 has been switched off to prevent a water impact. The presence of water that has entered may be signaled to the user of engine system 1 for example visually by an output on a display, or by an acoustic or haptic signal. Additionally, error entries may be made in a memory element of control unit 15.

The user of engine system 1 is able to drain the water that has entered air supply system 5 by opening a drainage valve 13, which is situated in section 12, and signal with the aid of an operating element 14 connected to control unit 15 that the water that had entered has been removed and that internal combustion engine 2 is ready for a restart. Operating element 14 is queried in step S5.

Only if in step S5 the confirmation of the user of engine system 1 has occurred (alternative: yes), a new start of internal combustion engine 2 is permitted in step S6.

What is claimed is:

1. A method for preventing a water impact in an internal combustion engine, comprising:
detecting whether water has entered an air supply system of the internal combustion engine; and
stopping the internal combustion engine if it is determined that water has entered.

2. The method according to claim 1, wherein the internal combustion engine is stopped by at least one of:
stopping a supply of fuel; and
stopping a generation of an ignition spark.

3. The method according to claim 1, wherein, simultaneously or immediately after stopping the internal combustion engine, an intake valve is kept closed permanently until a next start of the internal combustion engine.

4. The method according to claim 1, wherein, simultaneously or immediately after stopping the internal combustion engine, at least one of (a) a throttle valve and (b) a shutoff valve in an air supply system upstream from an intake valve in a cylinder is kept closed permanently until a next start of the internal combustion engine.

5. The method according to claim 1, wherein a new start of the internal combustion engine is permitted only after a confirmation and after an operation of an operating element.

6. A device for preventing a water impact in an internal combustion engine, comprising:
a water detector adapted to detect whether water has entered an air supply system of the internal combustion engine; and
a control unit adapted to perform an activation to stop the internal combustion engine if it is determined that water has entered.

7. The device according to claim 6, wherein the water detector is situated in a section of the air supply system in which water initially collects when entering.

8. An engine system, comprising:
an internal combustion engine; and
a device adapted to prevent a water impact in the internal combustion engine, the device including:
a water detector adapted to detect whether water has entered an air supply system of the internal combustion engine; and
a control unit adapted to perform an activation to stop the internal combustion engine if it is determined that water has entered

9. A non-transitory computer-readable storage medium with an executable program stored thereon, wherein the program instructs a microprocessor to perform a method for preventing a water impact in an internal combustion engine, the method including:
detecting whether water has entered an air supply system of the internal combustion engine; and
stopping the internal combustion engine if it is determined that water has entered.
